(19) United States
(12) Patent Application Publication
(10) Pub. No.: US 2016/0059618 A1
(43) Pub. Date: Mar. 3, 2016

(54) Palette of Ink Caps

(71) Applicants: Brian F. Abbott, Fort Worth, TX (US); Elizabeth D. Cook, Lewisville, TX (US)

(72) Inventors: Brian F. Abbott, Fort Worth, TX (US); Elizabeth D. Cook, Lewisville, TX (US)

(21) Appl. No.: 14/931,723

(22) Filed: Nov. 3, 2015

Related U.S. Application Data
(63) Continuation-in-part of application No. 14/458,039, filed on Aug. 12, 2014, now abandoned.
(60) Provisional application No. 61/871,014, filed on Aug. 28, 2013.

(51) Int. Cl. B44D 3/02

(52) U.S. Cl. CPC B44D 3/02

(57) ABSTRACT

Disclosed is an ink palette for use in artistic fields that require pigments to be readily available to an artist. Individual reservoirs are conjoined to form a matrix of reservoirs which may be cut to accommodate the artist's desire for color capacity. The ink palette is specifically adapted to the art of tattooing in that the palette may be secured to a work surface by the use of an ointment, like petroleum jelly, and each reservoir may have indentations on their bottoms in order to facilitate securement by the use of such compounds. Each reservoir may have a rim above the adjacent connectors so as to lessen mixing of the pigments.

### CROSS-REFERENCES TO RELATED APPLICATIONS

This application claims priority as a continuation-in-part of prior filed U.S. Non-provisional application Ser. No. 14/458,039, filed Aug. 12, 2014, and incorporates the same by reference herein in its entirety.

### FIELD OF THE INVENTION

The present invention relates to the field of artistry and more particularly relates to a palette of ink caps for use in arts such as tattooing.

### BACKGROUND OF THE INVENTION

Currently in the field of tattooing, an artist uses a reciprocating needle to inject ink into the skin of a subject in order to achieve the image desired by the subject. Ink is placed in a reservoir of a needle, which is then used to repeatedly poke holes in a subject's skin. The ink then fills and, essentially, dyes the lower skin layers. During the procedure, extra ink is stored in structures known as “ink caps” which are, often times, caps from the ends of pipes. The ink caps are essentially cylindrical or frusto-conical hollow structures that serve as wells for extra ink. It is intended that after use the user would dispose of used ink caps in an effort to maintain a sterile environment for successive customers. These caps are positioned on a surface and usually secured by some form of ointment which serves as an adhesive. This process can take a significant amount of time. Also, unfortunately, the ointment, usually a petroleum jelly, does not secure the caps very well and over the course of extensive tattoos there is an increased chance of tipping, spilling and other accidents (FIGS. 1-6). Palettes have been made holding these caps, but this is then an extra structure in the area in which a subject is getting tattooed, which can generate a sterilization risk.

The present invention is a palette for use in any situation where separate paints of inks are desired. It has particular application in the field of tattooing. The palette is a conjoined set of ink caps which may be cut to desired capacity. Being conjoined, the ink caps are less likely to tip, fall or spill their contents and, when adhered to a surface with ointment, the synergy of the multiple caps creates a more stable storage surface.

The present invention represents a departure from the prior art in that the palette of the present invention allows for selective multiple ink caps to be used in a given artistic application without the need of additional stabilization structure and for a more rapid set-up.

### SUMMARY OF THE INVENTION

In view of the foregoing disadvantages inherent in the known types of ink palettes, this invention provides a cost-effective palette solution. As such, the present invention's general purpose is to provide a new and improved ink palette that is easily adapted for different applications, cost effective to manufacture and capable of providing a superior hold to a surface for increased stability.

To accomplish these objectives, the ink palette comprises a plurality of ink caps that are conjoined into a matrix. The matrix of ink caps may then be cut to a desired size and capacity due to color selection. In the case of a tattoo artist, the palette is then positioned and secured to a surface with the use of an adhesive, like petroleum jelly. Small indentations, which may be a design like a logo, create an uneven surface which aid in the securement of the palette. The use of a matrix not only provides a more stable arrangement for the ink caps, it also greatly reduces the time needed to prepare the work surface and materials.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIGS. 1-6 are a series of perspective views detailing the state of the prior art.

FIG. 7 is a top perspective view of a palette embodying the present invention.

FIG. 8 is a bottom perspective view of the palette of FIG. 7.

FIG. 9 is a side perspective view of the palette of FIG. 7.

FIGS. 10-13 are a series of perspective views detailing the method using the new palette according to the present invention.

FIG. 14 is a perspective view of an alternate palette embodiment.

FIG. 15 is an alternate perspective view of the palette of FIG. 14.

FIG. 16 is a bottom plan view of the palette of FIG. 14.

FIG. 17 is a top plan view of the palette of FIG. 14.

FIG. 18 is a side elevation of the palette of FIG. 14.

FIG. 19 is a sectional view of the palette of FIG. 14.

FIG. 20 is an alternate view of the palette of FIG. 19.

### DETAILED DESCRIPTION OF THE PREFERRED EMBODIMENT

With reference now to the drawings, the preferred embodiment of the ink palette is herein described. It should be noted that the articles “a”, “an”, and “the”, as used in this specification, include plural referents unless the content clearly dictates otherwise.

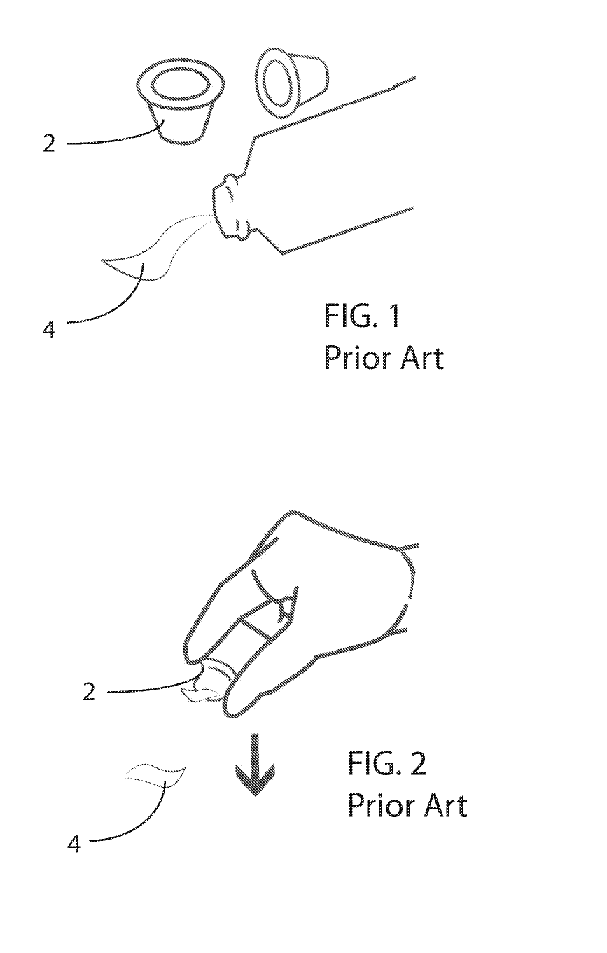

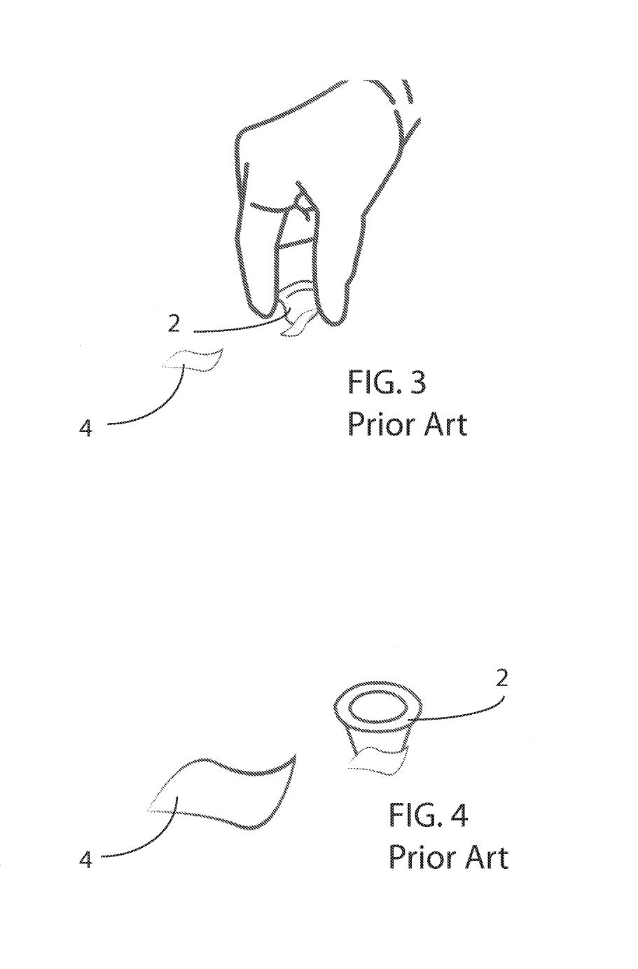

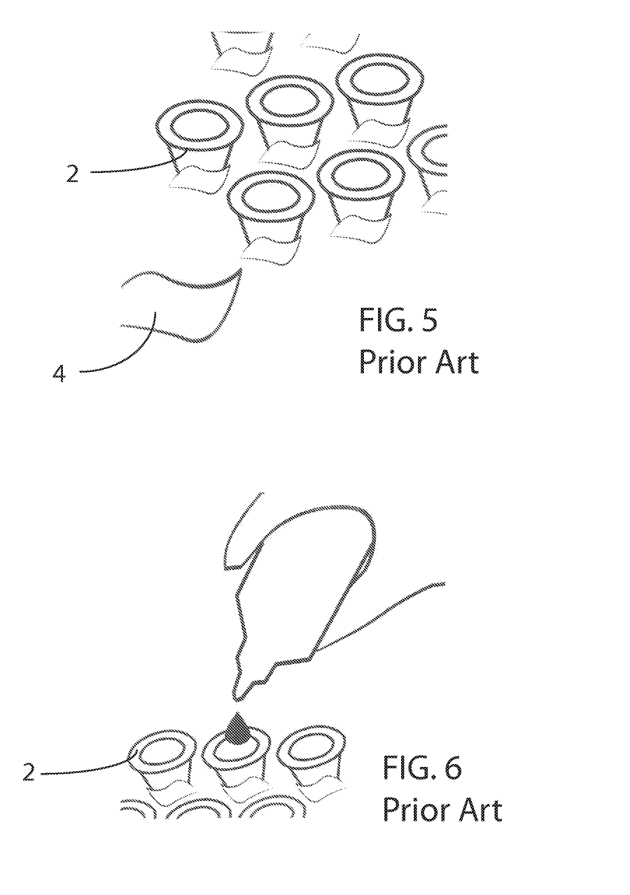

With reference to FIGS. 1-6, the prior art shows a plurality of individual ink caps and the work surface being prepared (FIG. 1) by an artist applying a daub 4 of a mild adhesive, usually a petroleum jelly or similar substance, to the surface. An ink cap 2 is placed into the daub 4 (FIG. 2) and removed, coating its bottom surface (FIG. 3). The ink cap is then placed on the surface (FIGS. 4 and 5) and the process repeated until all of the caps are adhered (FIG. 6) and then the individual caps are filled with an ink or other similar pigment medium. Unfortunately, the order of the ink caps 2 shown in FIG. 6 does not remain throughout the process of using the ink. The caps are individually adhered and, as the adhesive is mild, are frequently individually tipped or otherwise displaced, possibly even disturbing adjacent ink caps and creating a mess of the work surface.

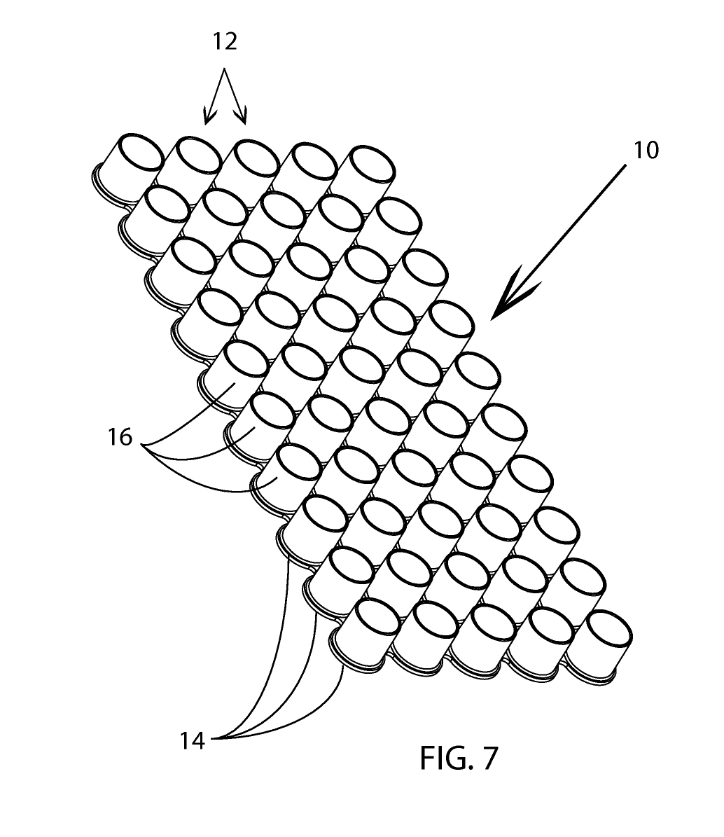

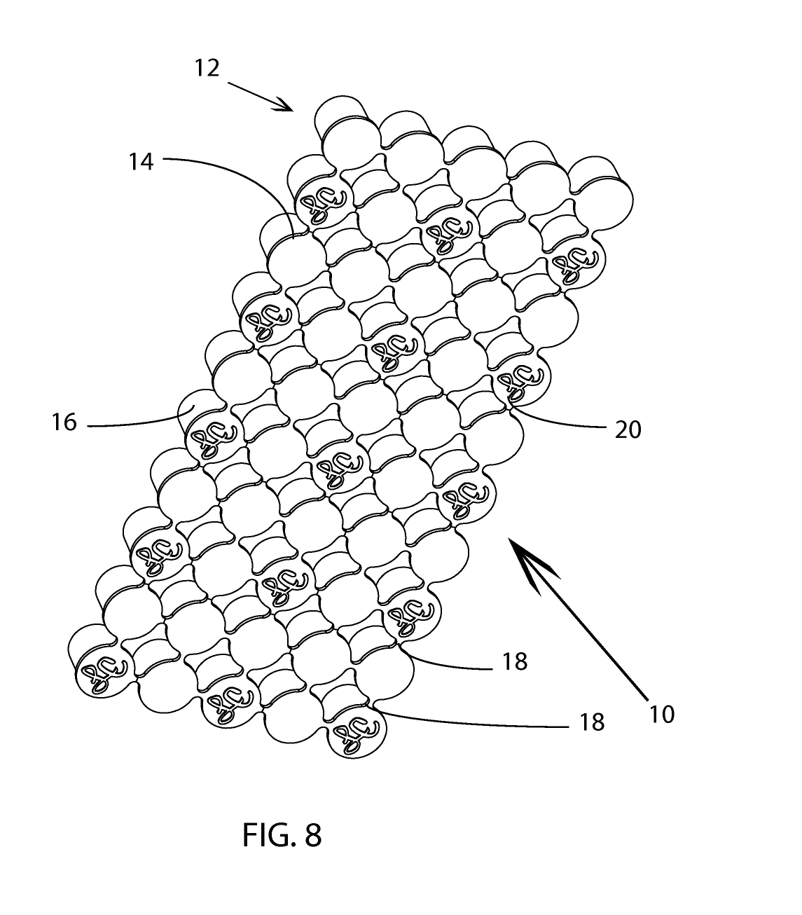

The present invention is a palette comprised of a plurality of ink caps. One embodiment 10, shown in FIGS. 7-9, arranges the ink caps 12 in a matrix. Each ink cap 12 has a cylindrical or frusto-conical reservoir wall 16 positioned over a base 14. The base of each ink cap 14 is joined to adjacent bases 14 by connectors 18 which may be cut to create an individual palette of just the number of ink caps 12 that an artist desires. As the ink caps 12 are interconnected, they synergistically contribute to adjacent ink caps' stability and adhesion to the surface. Additional texturing, such as logo 20, may also be fashioned in the surface of ink cap bottoms 14 in an effort to provide additional adhesion efficiency. The texturing may be applied to every ink cap 12 or just selected ones. As in the prior art, when adhered to the work surface, the ink caps 12 may be filled with ink for an artistic session.

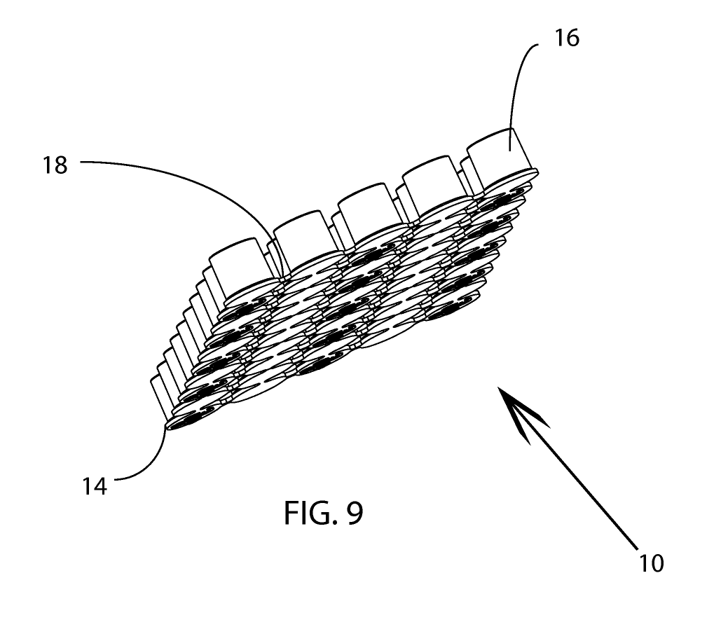

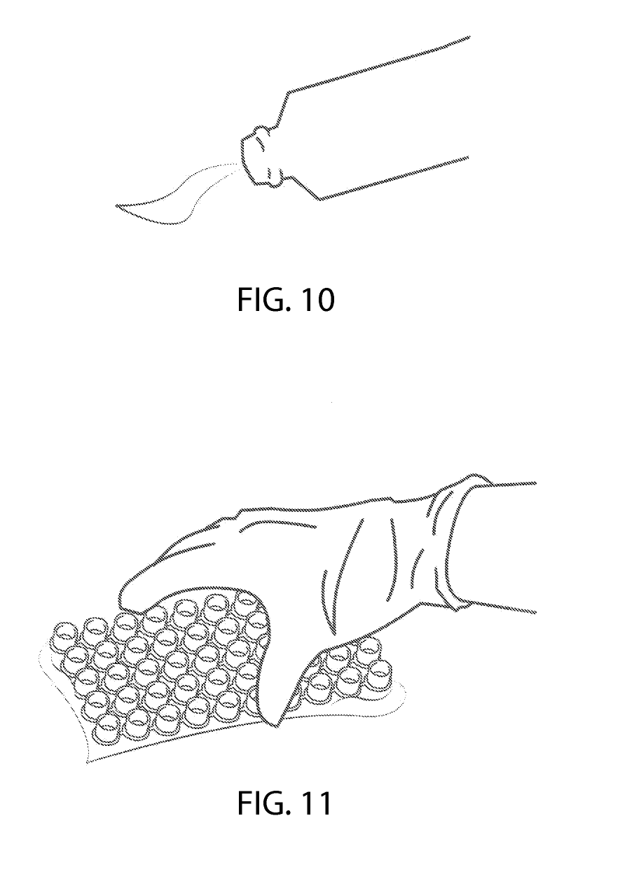

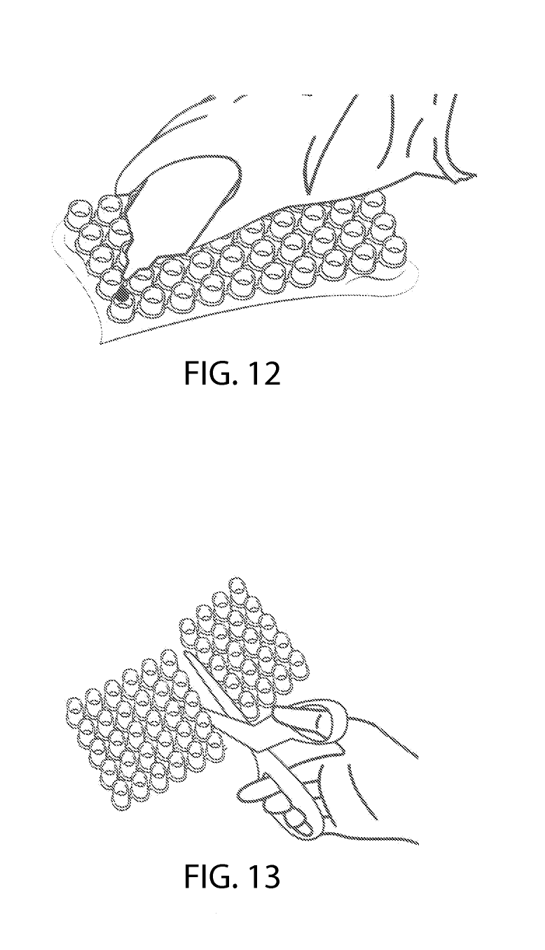

In use, FIGS. 10-14, a surface is prepared with a daub 22 of the same mild adhesive as in the prior art. The daub 22 is broad enough to securely hold an entire palette. The palette 10 is then positioned directly on the prepared surface, in the daub 22, and individual caps 12 are then filled with ink. Cutting the palette is an easy process if the palette 10 is made of a soft enough polymer or other suitable material.

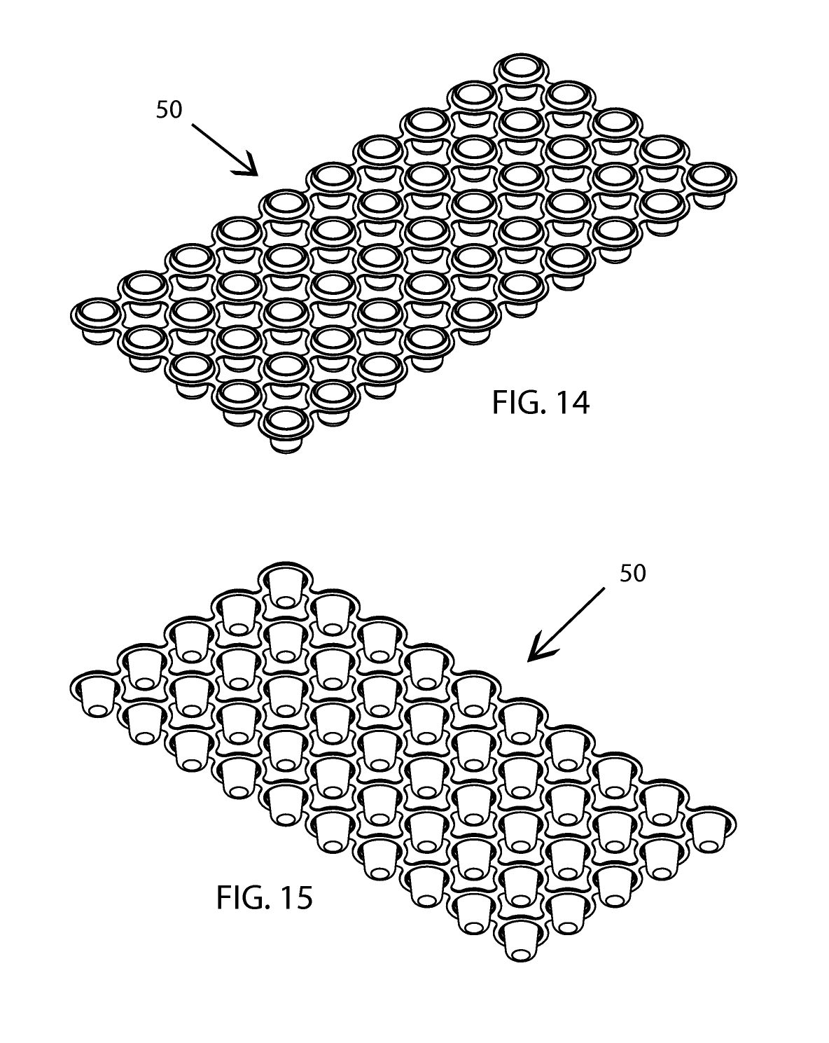

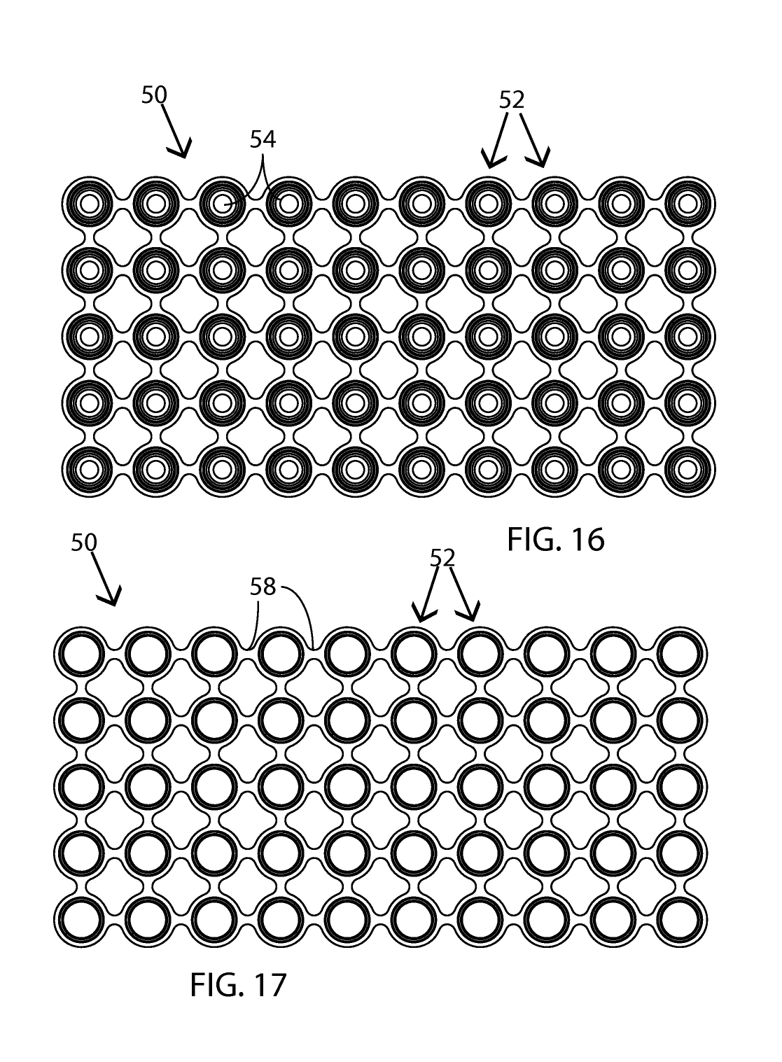

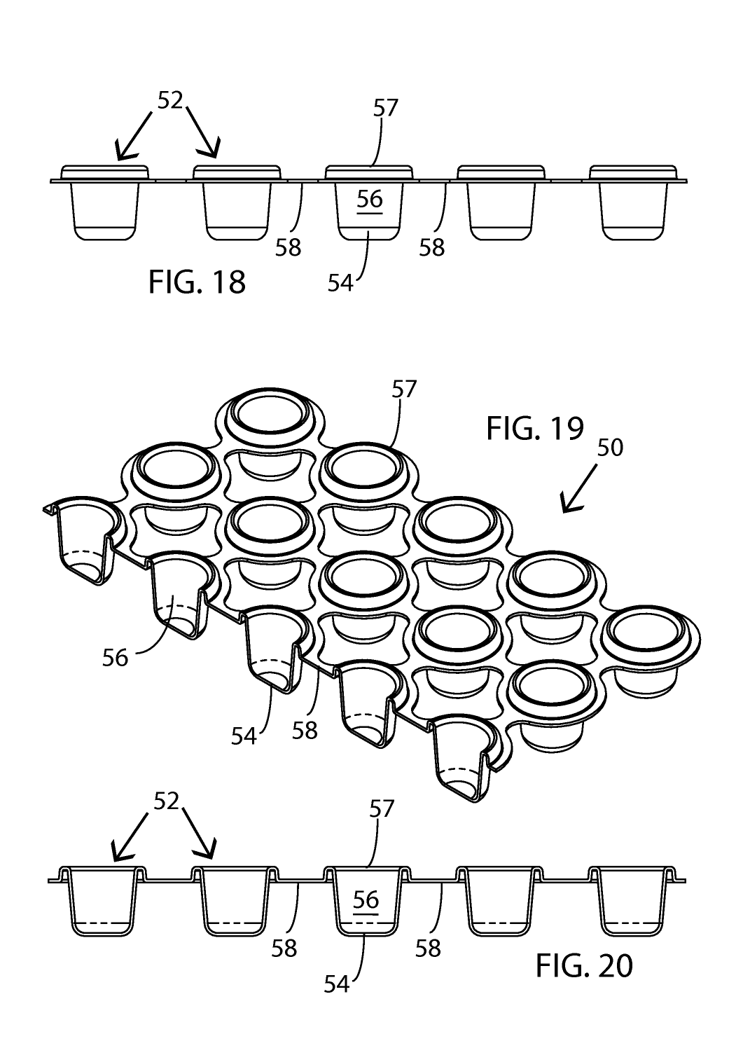

Another palette embodying aspects of the invention is depicted in FIGS. 14-20. With this palette 50, the connectors 58 are located towards the top of each ink cap 52, generally on an upper half of the ink cap reservoir wall 56. Bottoms 54 are generally unconnected and reservoir walls 56 may be of any suitable shape, however they extend above the connectors 58 and form a rim 57. Placement of the connectors 58 towards the top of the ink caps 52 provides greater stability to the palette 50 when in use; however, inks may spill out of an ink cap 52 and spread to another along the connector 58 if the rim 57 was absent. It is therefore recommended that a rim 57 be placed on ink caps 52 when using upper connectors 58. This rim should be high enough to prevent ink from pooling and overflowing into an adjacent cap. This height will be dependent upon the surface tension for ink. For most inks, a height of 0.095 inches will be more than sufficient, though a height as low as 0.010 could also suffice.

The present invention is described with particular relevance to the art of tattooing; however, the palette of the present invention may be utilized in any situation where a plurality of pigment sources are desired for an artistic endeavor.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. An ink palette comprising a plurality of ink cap reservoirs arranged in a matrix, each ink cap reservoir further comprising:
a. a reservoir wall and a bottom surface;
b. a plurality connective bars, each connective bar extending between adjacent ink cap reservoirs within the matrix and being located on an upper half of the reservoir walls of the adjacent ink cap reservoirs; and
c. a plurality of rims, one on each reservoir, each rim extending above the plurality of connective bars.

2. The ink palette of claim 1, a plurality of the ink cap reservoirs having a texturing pattern on an underside of the bottom surface of those ink caps.
